(19) United States
(12) Patent Application Publication
(10) Pub. No.: US 2023/0022971 A1
(43) Pub. Date: Jan. 26, 2023

(54) High Value Organic-Containing Nitrogen Fertilizers and Methods of Manufacture

(71) Applicant: Anuvia Plant Nutrients IP Holdings LLC, Winter Garden, FL (US)

(72) Inventors: Jeffrey C. Burnham, Marco Island, FL (US); Gary L. Dahms, Soda Springs, ID (US); James P. Carr, Deer Island, FL (US); Hugh Broadhurst, Reno, NV (US)

(73) Assignee: Anuvia Plant Nutrients IP Holdings LLC, Winter Garden, FL (US)

(21) Appl. No.: 17/870,513

(22) Filed: Jul. 21, 2022

Related U.S. Application Data
(60) Provisional application No. 63/224,128, filed on Jul. 21, 2021.

(51) Int. Cl. C05C 3/00; C05G 5/12

(52) U.S. Cl. CPC C05C 3/005; C05G 5/12

(57) ABSTRACT

The invention is directed to organic fertilizers having commercial levels of nitrogen reacted with organic substances. The scalable process comprises adding an organic processing center to a fertilizer granulation plant specifically for the treatment of organics with an acid that acidifies, heats and liquifies a mix resulting in the hydrolysis of most or all organic material and polymers. For ammonium sulfate-based fertilizer this mix is only reacted with concentrated sulfuric acid. For ammonium phosphate fertilizers, this mix is reacted with both concentrated sulfuric acid and a concentrated phosphoric acid. The acidified organic mixes are piped to an existing or new granulation plant where it is injected with anhydrous ammonia in a tee mixer/reactor that results in a partially neutralized melt. Subsequently a sterilized and liquefied organic melt is sprayed over recycled bed material for production of granules before drying. Fertilizers made as disclosed provide a “green”, dual nitrogen-release profile when applied to crops releasing a bolus of nitrogen over one to two weeks following application followed by a slow or enhanced efficiency release of nitrogen over weeks of the growing season.

### REFERENCE TO RELATED APPLICATIONS

This application claims priority to U.S. Provisional Application No. 63/224,128, filed Jul. 21, 2021, the entirety of which is incorporated by reference.

### BACKGROUND

### 1. Field of the Invention

This invention is directed to methods, systems, and processes for the manufacturing of organic-containing nitrogen fertilizers and the fertilizer product manufactured by these methods. In particular, the invention is also directed to the manufacture of fertilizers with predetermined concentrations of nitrogen with phosphate and/or sulfate, especially involving an organic processing center which can be added directly to existing fertilizer granulation facilities. This invention is also directed to organic-based solid nitrogen fertilizers.

### 2. Description of the Background

The disposition of waste organics in municipalities is a huge problem in society today. The invention teaches how to use waste organics to produce a useful and valuable fertilizer especially by taking advantage of adding an organic processing center onto existing fertilizer granulation plants that exist throughout the U.S and much of the world. Municipal organic wastes include such as, for example, domestic septage, biosolids as from a municipal waste treatment plant, farm and factory organic wastes that are collected or otherwise find their way to waste-water treatment, sewer run offs, pharmaceutical wastes including fermentation and processing wastes, microbial digests, food wastes and food byproducts, animal manures, digested animal manures, organic sludge, organisms and microorganisms and all combinations thereof. Other wastes that can be used include agricultural organic wastes, humates and algae as harvested from eutrophic lakes. Many of these are classed as wet organics which range up to 60% solids. Others are considered dry organics which contain more than 60% solids. These require conditioning to prepare them for an effective acid hydrolysis. The market value for agricultural fertilizers is principally based on their nitrogen and sulfur content. In recent years the utilization of organics in such fertilizers has increased such that their value is now sufficient to encourage their commercial manufacture. A need exists for a practical, safe and economic method for reacting organics with the nitrogen, sulfur and phosphate content of fertilizers containing such organics to a level approaching that of standard commercial mineral fertilizers, e.g., eight to twenty percent for nitrogen, 8 to 24 percent for sulfur and 8 to 30 percent for phosphate. Moreover, a properly manufactured organic-containing fertilizer will have an advantage in that a significant percentage of its nitrogen will be of the slow-release type. A slow-release or controlled release fertilizer or Enhanced Efficiency Fertilizer (“EEF”) is one in which the nutrient, e.g., nitrogen as in ammonium ions, phosphorus as phosphate and/or sulfur as sulfate, becomes available in the soil column at rates slower than fast-available nutrients as from traditional fertilizers such as urea, ammonium sulfate and diammonium phosphate. This slower action and/or prolonged availability of the nutrient in the soil column is very desirable and provides nutrients to the plant throughout the plant growing cycle with the implication that less nitrogen needs to be applied to the soil or crop thereby reducing the potential of environmental contamination and reducing the cost of fertilizer usage. Further, slow-release fertilizers are much more environmentally friendly than traditional inorganic fertilizers. For example, slow-release fertilizers of this invention not only provide nutrients to plants over much of the productive crop cycle, they also are more environmentally friendly in that they: a) retain more of the contained nutrients in the soil column thereby avoiding loss of the nutrients via leaching into the ground water, and b) do not volatize their contained nutrients, especially nitrogen, into the environment upon application to the soil environment.

A series of U.S. Patents (e.g., U.S. Pat. Nos. 5,984,992; 6,159,263; 6,758,879 and 7,128,880) generally disclose methods of production of high nitrogen, organically-enhanced ammonium sulfate fertilizers made with biosolids utilizing a pipe-cross reactor as originated by the Tennessee Valley Authority (TVA). The pipe reactor is defined by the International Fertilizer Development Center (IFDC) in the IFDC Fertilizer Manual (1998. Editors: United Nations Industrial Development Organization (UNIDO) and International Fertilizer Development Center IFDC). Kluwer Academic Publishers in cooperation with UNIDO (Vienna, Austria) and IFDC, Muscle Shoals, Ala., USA. (see pages 232; 280; 364-366; 440-441) 1998), p 440 as: a pipe reactor consists basically of a length of corrosion-resistant pipe (about 5-15 m long) to which phosphoric acid (sulfuric acid or), ammonia (commonly anhydrous ammonia) and often water are simultaneously added to one end through a piping configuration resembling a tee, thus the name ‘tee reactor.’ The tee mixer or reactor was also developed by Esso Chemical and Incitec in the same period of time (see Fischbein and Brown, 1988; Improved Incitec process in Alberta plant fulfils North American blend-compatibility criteria. 1988. A report based on a paper by M. Fischbein, of Esso Chemical Canada Ltd, and A. M. Brown of Incitec Ltd, presented at the IFA Technical Conference, Calgary in September 1988. Describes using mixing tee connected to a pipe reactor). The TVA modified the Tee Reactor to include another pipe inlet located opposite the acid inlet, giving the unit a “cross” configuration and thus the name “pipe-cross reactor” (FIG. 3A). The above U.S. patents used the pipe-cross reactor with the three inputs being sulfuric acid, anhydrous ammonia and biosolids slurry or dewatered sludge.

Both the IFDC Fertilizer Manual (1998) and the Fertilizer Technical Data Book (Sepehri-Nik, H. K., FCI Fertilizer Technical Data Book. FCI Ag Chem. (see pages 195-201, 2000) refer to these pipe-cross reactors. Pipe-cross reactors have been part of standard fertilizer granulation facilities in the U.S. and the world. These pipe-cross reactors deliver a fertilizer melt of partially ammoniated acidified mix to the granulator shaping device and more efficiently evaporate undesired water from the fertilizer mix than other devices, but these references demonstrate a long-felt need for improvement. For example, the major shortcoming of the pipe-cross reactor as used by U.S. Pat. Nos. 5,984,992; 6,159,263; 6,758,879 and 7,128,880 is that if organic slurries or dewatered sludges are to be one of the three inputs to a pipe-cross reactor along with simultaneously added acid and ammonia, the effect of acidification of the organic material is greatly diminished as much of the acid is instantaneously neutralized by the introduction of the ammonia base prior to the acid being able to hydrolyze the organic macromolecules to smaller units.

Organic processing requires aggressive acid hydrolysis. The pipe-cross reactor with simultaneous inputs of acid and ammonia lowers the acid hydrolysis reactions as a proportion of the acid is instantaneously neutralized by the strong base ammonia entering the pipe-cross reactor from the opposite side of the reactor thereby reducing the acid's hydrolytic activity.

Thus, there is a long-standing need for practical and economic means of increasing the economic value of municipal organic materials through increasing their elemental nutrient content to create effective saleable fertilizers.

### SUMMARY OF THE INVENTION

The present invention provides new tools and methods for the manufacture of fertilizers, and in particular organic-containing inorganic fertilizers and the fertilizers manufactured.

Organically-enhanced inorganic ammonium sulfate and ammonium phosphate fertilizer have been created that improved upon the earlier pipe-cross reactor process, for example, by separating out the acidification process from the ammoniation process thereby maximizing the hydrolytic and fluidizing effect of adding the concentrated acids to the organic input (e.g., see U.S. Pat. Nos. 7,947,104; 8,557,013; 8,992,654; and 9,856,178). This separation also meant that the organic conditioning and acidification could be practically centralized in an organics processing center which can be economically and effectively added onto the front of existing fertilizer granulation facilities that are located throughout the U.S. and the world (FIG. 1). This added manufacturing facility creates an economic way to manufacture “green” organic-containing fertilizers that can help conserve carbon and enhance sustainability in agriculture. Further, the use of separate reaction vessels for both the acidification process and the ammoniation process permitted better control of acid reaction retention times for molecular interactions such as establishing bonding between the hydrolyzed organic matter and the charged inorganic ions present.

The invention disclosed herein comprises methods of manufacturing a fertilizer comprising: conditioning an organic material, and hydrolyzing the organic material at least partially by adding one or more mineral acids, especially the strong dehydrating acid—concentrated sulfuric acid, to create an exothermic reaction and form an acidified liquid mixture; subsequently treating the acidified liquid mixture with anhydrous ammonia under pressure forming an ammoniated liquid melt; neutralizing said melt in a granulator, neutralizing the melt to desired physiological fertilizer pH using additional anhydrous ammonia spared into a granulator and forming the pH adjusted mix into granules in a granulator, and drying the formed granules, cooling the dried granules to prior to storage, transportation and subsequent usage. Organic material is comprised of a) wet or semisolid materials (12% solids to 60% solids) such as dewatered municipal biosolids or partially processed agricultural and industrial waste materials, dewatered algae harvested from eutrophic surface water sources, digested or undigested animal manures and residuals, microorganisms, extracted liquid organic fractions from municipal solid waste, digested and undigested food stuffs microbial digests of organic products, organic biosolids, pharmaceutical fermentation wastes, wastewater plant biosolids, or combinations thereof; and/or b) dried or partially dried organics (between 60% and 100% solids) such as heat-dried municipal biosolids, humates containing fulvic and/or humic acids, food byproducts and partially-dried or dried agricultural organics, such as almond hulls or peanut shells, or combinations thereof. Additionally, dried organics may be mixed with wet organics to also achieve the correct percent solids for optimum acid hydrolysis.

In the preferred embodiment the organics must be conditioned and prepared for exposure to a strong mineral acid for effective hydrolysis. In the case of dried organics, such as dried municipal biosolids, or dried or partially-dried agricultural wastes, such as almond hulls or peanut shells for example, these are conditioned through a process of grinding to a small size prior to acid exposure. This grinding is to reduce the organic material size to particles to less than 2.0 mm in diameter, preferably less than 1.0 mm in diameter and more preferably less than 0.1 mm in diameter (see FIG. 9).

It has further been found that such dried biosolids materials are further enhanced for acid hydrolysis if they are first soaked and softened (see FIG. 9) prior to the grinding or milling treatment and subsequent acid exposure. This can be accomplished by soaking said organic materials in: a) an aqueous solution for a period of time, greater than 10 minutes, preferably for greater than 30 minutes, and more preferably greater than 60 minutes prior to acid exposure; or b) a dilute acid solution as in a dilute nitric acid (concentration range: 0.6% to 10% with a preferred range of 0.6% and 3% at an elevated temperature (150° F. {65° C. } to 250° F. {121° C. } for 1 to 4 hours) for similar times as for aqueous soaking and c) a solution of alkali such as a hydroxide, e.g., a potassium hydroxide solution (1% to 10% KOH at a temperature of 240° F. {115° C.} for 1 to 4 hours at pH 14) to assist in breaking down the molecular structure of the organics, and d) treatment of the organic with an enzyme solution, e.g., a cellulase in the case of cellulosic agricultural wastes, to further render them more susceptible to the subsequent strong acid hydrolysis.

A major advantage is imparted by treating the dry organics first with a soaking and softening procedure prior to a mechanical mixing, grinding or milling process. The wetting of the dry organics prevents fires or explosions which are known to occur during the processing of dry organics, especially if they are to be ground or milled during processing. Dried biosolids are well known to burn or explode during their processing and many municipal plants producing dried biosolids granules or pellets have been destroyed.

Preferably the hydrolytic acid comprises a concentrated mineral acid such as sulfuric acid that is 97% strength or higher. Multiple acids may be included such as sulfuric and phosphoric. Preferable, the acids used comprise at least two acids including sulfuric acid which are added in sequential steps with sulfuric acid added first.

Preferably the acidified liquid mixture is maintained at about 170° F. (76° C.), or from about 200° F. (93° C.) or preferably to about 220° F. (104° C.) or above. The hydrolysis is conducted for at least 6 minutes, preferably for at least 15 minutes and more preferably for 30 minutes or more. Preferably the pH of the acidified liquid mix is pH 1.0 or less or preferably pH 0.1 or less. The pressure of the acidified liquid mix may be maintained at ambient atmospheric conditions. Alternatively, the acidified mix may be maintained at a pressure is between about 15 psi and about 25 psi.

At the completion the acid hydrolysis, the acidified mix is pumped to an ammoniation vessel wherein gaseous or liquid anhydrous ammonia is added thereby creating increased temperatures of over 280° F. (138° C.) and vessel pressures over 28 psi. Preferably the ammoniation reaction of the mix is conducted at temperatures over 300° F. (149° C.) and at pressures over 32 psi. More preferably the ammoniation temperature is over 330° F. (165° C.) and over 36 psi. The time of the ammoniation reaction is determined by the equipment utilized for this reaction. If a tee reactor the time of the ammoniation reaction is quite short in the order of 5 to 10 seconds. This time can be extended by increasing the length of the pipe or tube from the tee reactor to the granulator typically for an additional 10 to 20 seconds. In a separate embodiment the ammoniation reaction can be conducted in a pressure tank vessel in which the ammoniation reaction is maintained for a period of minutes consisting of at least 1 minute up to 30 minutes, preferably between 5 and 10 minutes.

Preferably fertilizer is formed as granules which may be coated with an agent such as, for example, a dedusting agent, a nutrient, a bioactive agent, or a combination thereof.

This invention comprises a fertilizer made by the methods disclosed herein. A preferred fertilizer is comprised of at least partially hydrolyzed organic material complexed with one or more nutrients which are chelated or electrostatically bound to the hydrolyzed organic material, wherein the fertilizer has a hardness of between about 4 and about 12 pounds or a bulk density of between about 50 and about 58 pounds/cubic foot. Preferably the fertilizer is homogenous throughout. Preferably the fertilizer contains one or more nutrients comprise one or more of nitrogen, phosphorus, potassium, sulfur, iron, manganese, magnesium, copper, calcium, selenium, boron, zinc and combinations thereof. Also preferably, the fertilizer of this invention has a slow-release nutrient profile that allows for the release of nitrogen to a soil at a rate slower than nitrogen release by fertilizer containing urea or ammonium sulfate as a nitrogen source. Preferably the fertilizer improves soil tilth, improves stress resistance of crops to heat and drought, and improves the micro-ecology of soil as compared to a non-organic fertilizer. A preferred fertilizer contains from about 8% to about 17% nitrogen, from about 0% to about 30% phosphorus, from about 0% to about 10% potassium, from about 5% to about 22% sulfur, from about 0% to about 5% iron, and from about 4% to about 20% organic compounds. Preferably the fertilizer which, once applied to a crop, provides one or more nutrients to the crop sufficient for all or a portion of a single growing season.

Another embodiment of the disclosure comprises systems for manufacture of a fertilizer comprising: first a conditioning process to prepare the organic input for acid hydrolysis. Normally for dried organics such as dried municipal biosolids, this involves a first conditioning vessel, usually a tank, which is configured to hold a liquid mixture comprised of organic material and water—preferably residual process water, or a dilute acid solution, or an alkali or enzymatic solution, all specifically formulated to soak and soften the organic material as part of the conditioning process. The soaking and softening tank usually contains the organics in a suspension at the preferred percent solids needed for optimum acid hydrolysis. This is between 20% and 35% solids with the preferred suspension at 22% to 28% solids.

Additionally, the dried or cellulosic material is treated with a system comprising a mixer, grinder, flour mill, pug mill or ball mill configured to condition dried or cellulosic organic material by reducing the organic material to a smaller size suitable for acid hydrolysis. This conditioning equipment preferably operably connected to a first conditioning vessel. This first vessel is configured to hold a liquid mixture comprised of organic material and water, or an acid solution, or an alkali solution, all for soaking and softening the organic material as part of the conditioning process; sequentially a second vessel, wherein this second vessel is a tee-mixer/reactor, a pipe reactor, a tube reactor, or a cylindrical tank reactor for acidification of the conditioned organic by a strong mineral acid as concentrated sulfuric acid; and sequentially a; a third vessel which receives the acidified liquid mixture from the second vessel. Said third vessel is a tee-mixer/reactor, a pipe reactor, a tube reactor, or a cylindrical tank reactor which has a separate opening for an input of anhydrous ammonia; and a granulator and which forms the fertilizer and completes the neutralization of the fertilizer by the introduction of additional gaseous or liquid anhydrous ammonia via a sparging apparatus; and subsequently a dryer to reduce the water content and create a dry granule with a percent moisture less than 3 percent by dry mass of the finished fertilizer.

The systems as disclosed here can be relatively easily and relatively inexpensively added to an existing fertilizer granulation facility.

Other embodiments and advantages of the invention are set forth in part in the description, which follows, and in part, may be obvious from this description, or may be learned from the practice of the invention.

### DESCRIPTION OF THE FIGURES

FIG. 1. Concept drawing of an organic processing center added to an existing or new fertilizer granulation facility with an optional bioactive additive facility.

FIG. 2. Common granulation plant layout for ammonium sulfate or ammonium phosphate fertilizers.

FIG. 3A. Schematic of cross-pipe reactor for concentrated acid addition and/or for anhydrous ammonia addition.

FIG. 3B. Schematic of tee mixer/reactor for concentrated acid addition and/or for anhydrous ammonia addition.

FIG. 4. Engineering drawing of ammoniation tee mixer/reactor.

FIG. 5. Conversion of pipe cross reactor to a tee mixer/reactor in an existing standard fertilizer granulation plant.

FIG. 6. Engineering drawing of an organic acidification cylindrical reaction vessel with mixing via a recirculation pump.

FIG. 7. Embodiment utilizing additional tee-mixer/reactors for secondary acid addition and ammoniation for the manufacture of ammonium sulfate.

FIG. 8. Acidification embodiment with recirculating vessel reactor for the manufacture of organically-enhanced, ammonium sulfate fertilizer.

FIG. 9. Embodiment utilizing a soaking and grinding/milling conditioning process for dry organics prior to using a tee mixer/reactor for primary organic acidification and hydrolysis with an acidification embodiment utilizing a reaction vessel with mechanical agitation for the production of organically-enhanced, ammonium sulfate.

FIG. 10. Organic processing facility for the manufacture of ammonium phosphates utilizing a recirculating vessel reactor for primary organic acidification with tee mixer/reactors for phosphoric acid addition and for ammoniation in the production of organically-enhanced, ammonium phosphate fertilizer.

### DESCRIPTION OF THE INVENTION

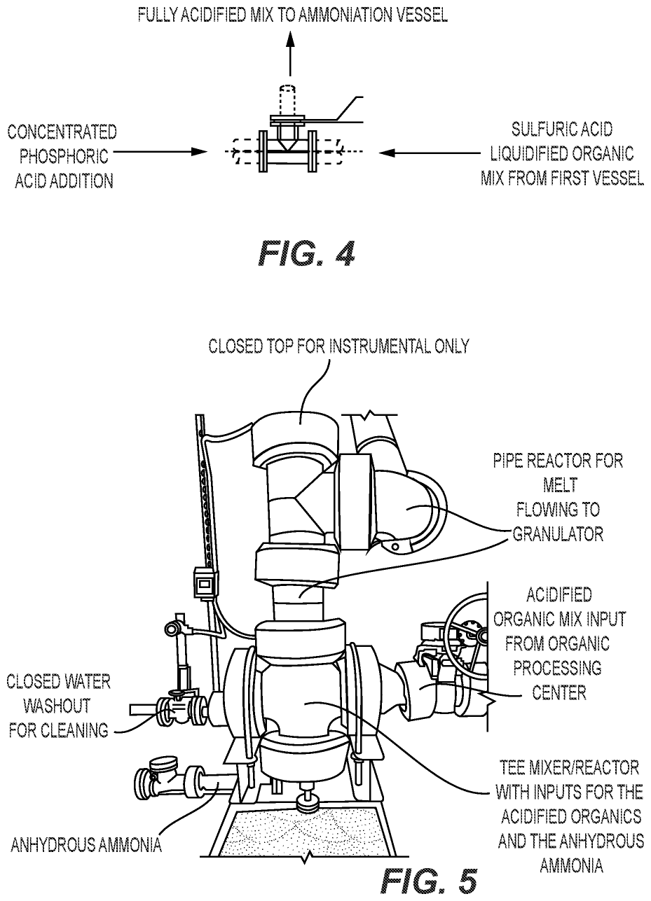

The present disclosure provides a method for manufacture of a solid fertilizer wherein the starting materials comprise dry organics. The method involves a soaking and softening step followed by a mechanical mixing, grinding or milling step. The disclosure includes processes that incorporate “T” or tee-mixer/reactor technology in combination with acidification reaction vessel technology embodiments to manufacture large volume nitrogen fertilizer such as, for example, ammonium phosphate fertilizers and mono-ammonium phosphate. The present invention proposes that the organic handling, conditioning and acidification steps in the manufacture of granular fertilizers be carried out in a separate facility referred to as an Organic Processing Facility (OPF) that can be added to the front of standard existing fertilizer granulation plants. FIG. 4 shows a conversion of a pipe-cross reactor to a tee-mixer/reactor in a large and old existing fertilizer granulation plant. It has been surprisingly discovered that high-value fertilizers with specific and predetermined release profiles of one or more nutrients can be efficiently manufactured from organic materials using such a facility, including but not limited to raw and semi-processed organic materials such as biosolids, agricultural materials and industrial wastes. Such fertilizers can be specifically tailored to crops so that the release profile of the fertilizer matches the nutrient needs that arise during the growth and development of the particular crop. In addition, the process of the invention destroys not only all potentially harmful microorganisms, but releases organics from microorganisms, especially fungi and bacteria contained many organic waste materials, such as dewatered or dried municipal biosolids, and at least partially hydrolyzes many of the organic polymers including forms of biopolymers (e.g., DNA, proteins, carbohydrates, toxins, antibiotics, hormones, etc.) thereby inactivating them, along with forms of composite materials, and even forms of plastics. The resulting organic-containing granular fertilizer product is of high value and also contains the hydrolyzed monomers (e.g. amino acids, peptides, sugars, etc.) that are beneficial and desirable for a fertilizer. The invention further teaches that an additional post-manufacturing facility can be added on to the existing granulation plant at its product discharge that will provide additional granule coating or coatings that may contain bioactive substances such as pesticides, herbicides and microbes that can enhance crop production when applied to organically-enhanced inorganic fertilizers (Burnham and Siegel, U.S. Patent Application Publication No. 2020/0148605).

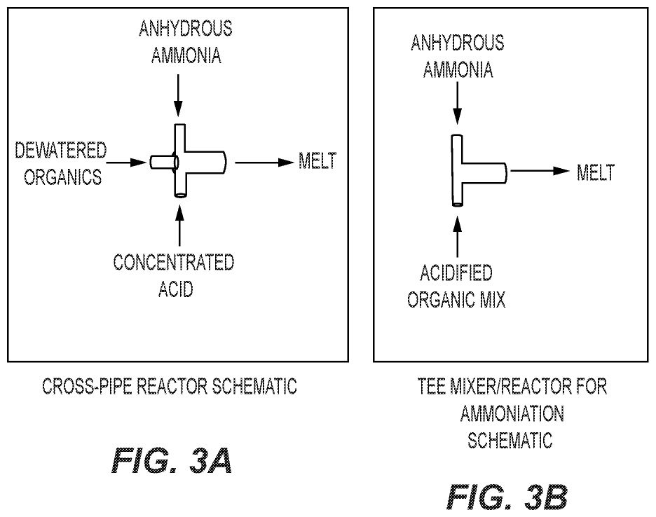

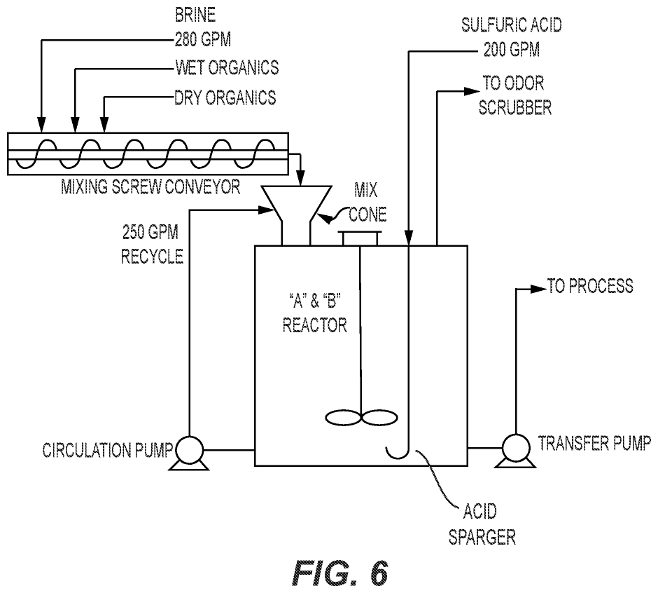

The present disclosure improves upon these patents by introducing a method of the utilization of dry organics by a conditioning process incorporating a soaking and softening process in combination with a mechanical mixing, grinding, or milling process to reduce the particle size of the dry organics for optimal acid hydrolysis and by incorporating acidification technology embodiments (FIGS. 6, 7, 8, and 9) for the primary concentrated sulfuric acid addition coupled to efficient proven tee-mixer/reactors for secondary acid addition and for concentrated phosphoric acid addition in the case of manufacturing ammonium phosphates. Standard fertilizer granulation plants contain an ammoniation system (FIG. 2). This invention eliminates the pipe-cross reactor for ammonia addition and replaces it with a tee-mixer/reactor (FIGS. 3A, 3B, and 4) for the separate reaction of anhydrous ammonia with the completed acid-organic mix.

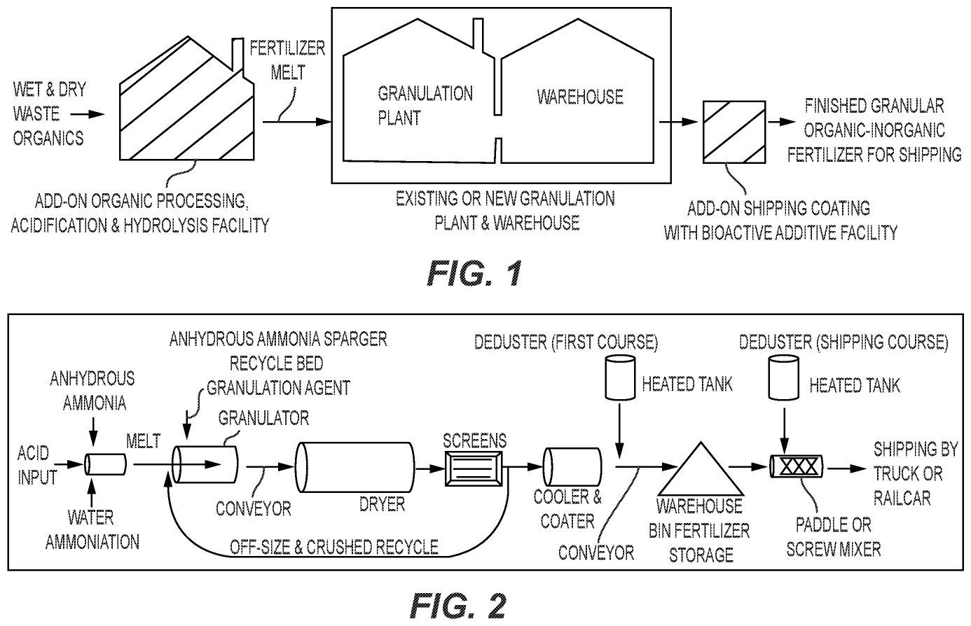

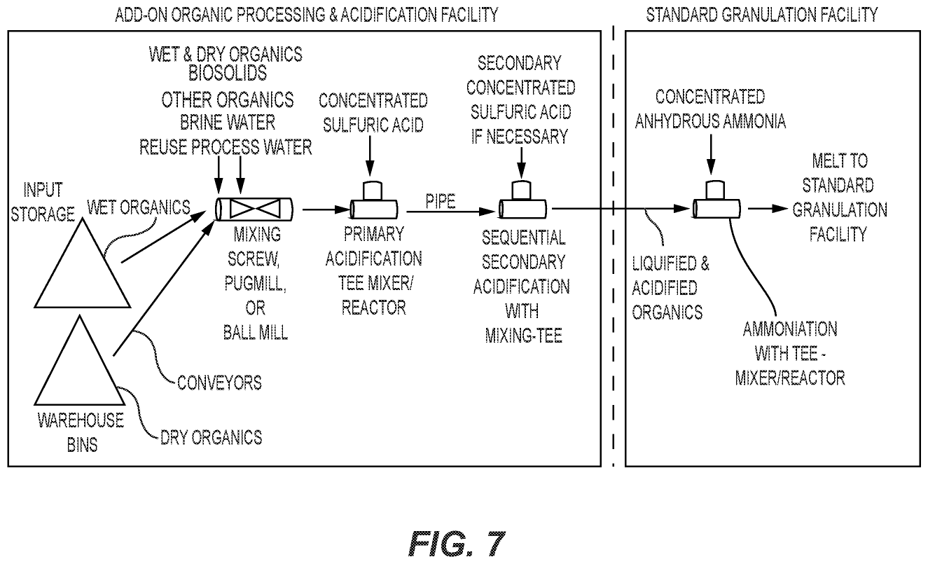

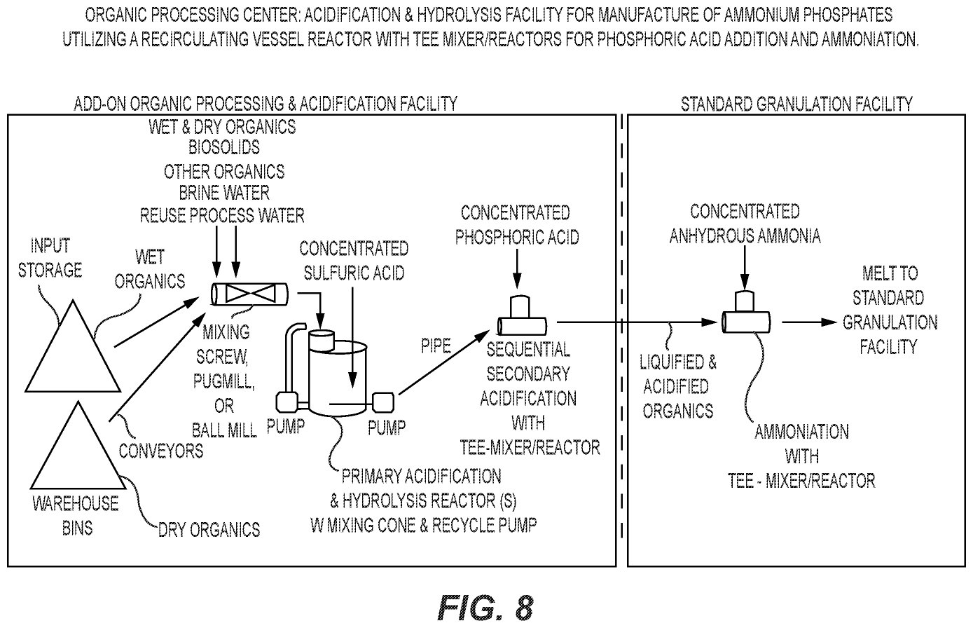

One embodiment of the invention is directed to methods for manufacture of a solid organically-enhanced, ammonium sulfate or ammonium phosphate fertilizer at an existing fertilizer granulation plant by adding an organic processing center to said plant which will receive, handle, condition, process and partially or completely hydrolyze such organics to prepare them for subsequent processing in the existing granulation plant (FIG. 1). This organics processing center will condition an amount of a dry organic material to be soaked in a solution and grinded to smaller sizes. It will also condition dry organics to less than an average of 1 mm diameter for optimum acid hydrolysis. It will transfer the conditioned mixture to an acidification reaction vessel in the form of a recirculating tank or a cylindrical tank with mechanical agitation (FIGS. 7, 8, and 9) to which is added a portion of concentrated sulfuric acid sufficient to create an exothermic reaction and a pH of the acid mix of about pH 1.0 or less, preferably about 0.5 pH or less, and preferably about pH 0.1 or less, wherein the amount of acid is reacted for a first period of time, for between 6 minutes and 60 minutes and preferably for 30 minutes; and sufficient to commence hydrolysis of the macromolecules present in the input organics; and sufficient to liquify the mix to a viscosity of about 2,000 cP or less and preferably about 1,000 cP or less. In these embodiments the concentrated sulfuric acid is added to the organic slurry or sludge via a dip-pipe or dip-tube into the mechanical mixing zone of a first recirculating vessel (FIG. 7) or directly into a mechanically agitated tank (FIG. 8). Preferably there may be only ambient pressure in the first vessel. In another embodiment these mixing tank or cylindrical vessels may be replaced with a tee-mixer/reactor. In this case the concentrated acid enters the acidification vessel via one of the two input arms of the tee-mixer/reactor along with the organic slurry or sludge (FIG. 6).

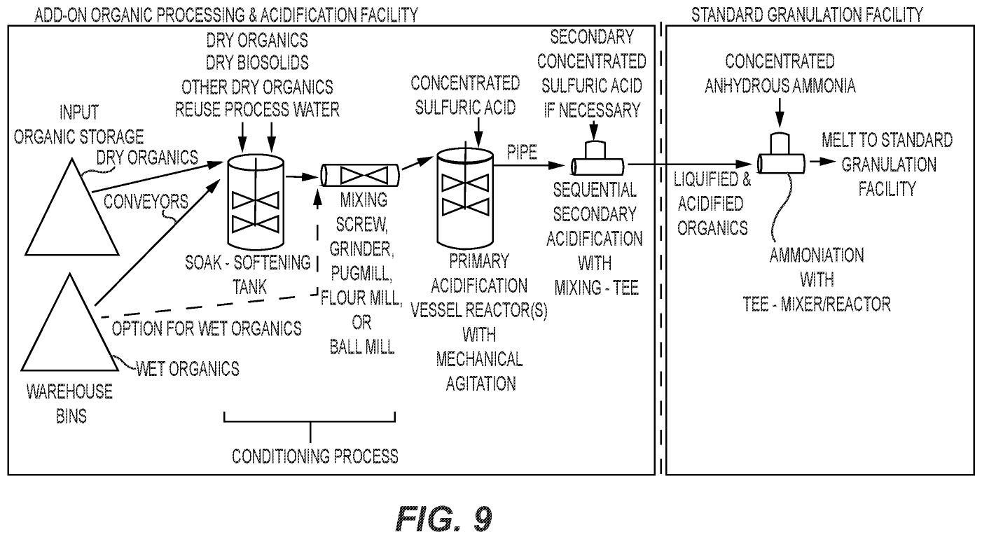

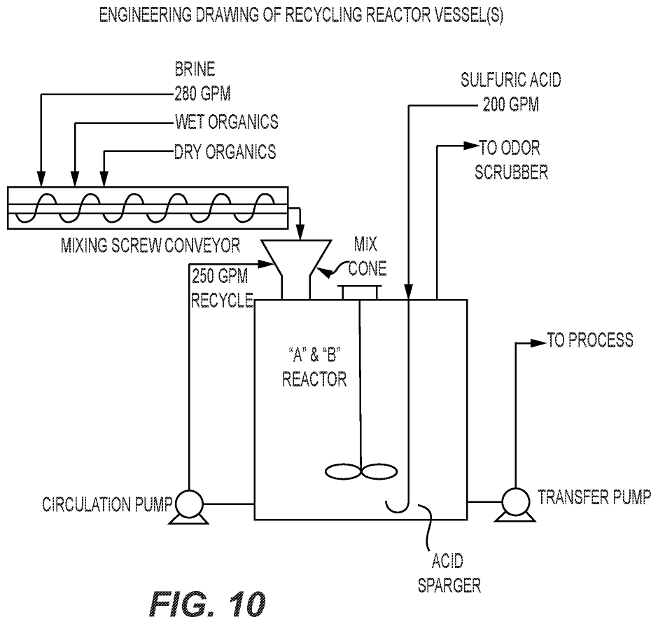

In the conditioning process dry organic material, and when necessary, recycled or process water, may be mixed and the soaked organic ground in a mixing vessel prior to the first acidification reaction vessel where they are thoroughly mixed and may form a uniform thixotropic paste that is pumped or easily transported. The mixing vessel may be a pug mill (see FIG. 9), a mixing screw conveyor, a multi-shaft mixer, a ribbon paddle blender, a static mixer, a high shear mixer, ball mill or other commercial high viscosity slurry mixer.

Alternatively, or in addition to, the dry organic material has or is mechanically reduced to a particle size diameter of about 2 mm or less, preferably about 1.0 mm or less, or more preferably to about 0.1 mm or less. Reduction of particle size can be achieved by passing the organic material through a high shear mixer, ball mill, or other such device which is operably connected to the first vessel for subsequent acidification. Mixers can be important when the input organic is in a dry granular form (as with a biosolids pellet) and must be wetted and converted by soaking and softening to a sludge as much as possible. Additional conditioning of dry material by mixing, grinding or milling may be necessary to reduce organic particle size for hydrolysis. Producing a uniform mix with as small diameter dry organic components as practically possible is important to maximize the effectiveness of the hydrolytic activity of the concentrated sulfuric acid to both liquify the organic mix, destroy contained microorganisms present in the organic matter and hydrolyze macro-organic molecules into small components. In the embodiment employing a recirculating tank the recirculating pump can be a shearing pump or a grinding pump which will assist in wetting and dissolving any dried granules or organic material as it passes through this pumping system. Preferably, if hydration as in a soaking and softening process is required, the organic material is hydrated with process water recovered from one or more steps of the method to minimize the use of water and or to prevent any loss of nutrient-containing water.

Preferably, the organic material prior to entering the first reaction tank or vessel is dry or hydrated to a solids content of between about 17% and about 40%, preferably the conditioned organic material has a solids content of from about 20% to about 80% and more preferably from about 20% to about 60%. In addition, a separate source of dried organics, such as dried pelletized municipal biosolids, may be utilized to mix with water, preferably process water or with other wet organics to bring a wet organic pre-reaction mix to the proper percent solids. The mixture may be optionally heated prior to the addition of acid, which is useful in climates where the organics are at about 40° F. or less.

The acidification of the conditioned organic input when performed in a tee-mixer/reactor, circulation tank or mixed vessel may achieve temperatures of about 170° F. (77° C.), or preferably from about 200° F. (93° C.) or ore preferably to about 220° F. (104° C.) or above. The hydrolysis is conducted for at least 6 minutes, preferably for at least 15 minutes and more preferably for 30 minutes or more. Preferably the pH of the acidified liquid mix is pH 1.0 or less or preferably pH 0.1 or less. The pressure of the acidified liquid mix may be maintained at ambient atmospheric conditions. Alternatively, the acidified mix may be maintained at a pressure is between about 15 psi and about 25 psi. The long acid reaction times are to ensure the hydrolysis of as much of the organics and polymers of the liquid mix as possible. Preferably the first concentrated acid comprises concentrated sulfuric acid at 90 percent or greater, preferably 98 percent.

The primary reacted sulfuric acidified and liquified organic material is pumped through a pipe optionally in the manufacture of ammonium sulfate or ammonium phosphates to a second acid reaction vessel (FIGS. 6 and 7) where it enters this vessel through a first “T” or arm of a tee mixer/reactor (see FIGS. 3, 4, 5) where any additional sulfuric acid may need to be added to bring the sulfur level to the fertilizer nutrient guarantee. Further, if an ammonium phosphate fertilizer is being manufactured, this first sulfuric acidified liquified organic mix is pumped to a pipe or vessel where concentrated phosphoric acid is added second through a tee reactor and reacted to meet phosphate levels in the fertilizer (FIG. 8). The reaction time for the phosphoric acidification vessel in the manufacture of ammonium phosphate fertilizers has a reaction time from 5 seconds to 6 minutes and preferably from 10 seconds to 30 seconds. These acidifications, liquification and hydrolysis reactions are preferably occurring in a separate Organic Processing Center (OPC) which has been added to an existing fertilizer granulation plant to enable the plant to manufacture the organic containing inorganic fertilizers of the present disclosure.

The completed acidified organic mix is then pumped to an ammoniation reaction vessel which is located within a standard granulation plant (FIG. 2). This reaction vessel is preferably a pressurized vessel and may be comprised of a tee mixer/reactor with pipe or a pressurized tank. FIG. 4 shows the conversion of a pipe-cross reactor ammoniation vessel to a tee-mixer/reactor in an old existing granulation plant. A tank vessel may be mechanically mixed, however normally the acid base reaction in this ammoniation vessel is violent sufficient to cause the complete mixing of the components and an increase in the temperature and pressure of the ammoniated liquid mixture in the vessel. The addition and reactions of the anhydrous ammonia determines the amount of nitrogen in the liquid mixture and ultimately the nitrogen percentage in the final fertilizer and is comprised of the anhydrous ammonia added in the ammoniation vessel plus the anhydrous ammonia added in the sparging process within the granulator. The resultant violent reaction serves to agitate the liquid mixture in the ammoniation reaction vessel for a period of time; and discharging the liquid mixture from the ammoniation vessel as an acid ammonium melt. The preferred temperature in the ammoniation vessel is over 280° F. (138° C.) with vessel pressures over 28 psi. Preferably the ammoniation reaction of the mix is conducted at temperatures over 300° F. (149° C.) and at pressures over 32 psi. More preferably the ammoniation temperature is over 330° F. (165° C.) and over 36 psi. The reaction period of time in the ammoniation vessel if it is a tee reactor with pipe is about 5 to 10 seconds minutes or more and preferably to between about 20 seconds to 30 seconds. If the ammoniation vessel is a pressurized tank then the preferred time of reaction is longer between 1 and 30 minutes, preferably between 5 and 10 minutes.

The viscosity of the ammoniated mixture is less than about 4,000 cP, preferably less than 2,000 cP. Viscosity of the starting organic material is typically in excess of about 100,000 cP and typically in about 150,000 cP at ambient temperature and does not change significantly even at elevated temperatures typical in a processing facility. For comparative purposes, at about room temperatures, molasses has a viscosity of 5,000 cP to 10,000 cP, honey has a viscosity of about 2,000 cP to 10,000 cP, chocolate syrup has a viscosity of about 900 cP to 1,150 cP, and olive oil has a viscosity of about 81 cP. With the addition of acid and heat according to invention, viscosity of the organic material decreases to preferably to less than 4,000 cP, and preferably to less than 2,000 cP. With the addition of anhydrous ammonia and the added temperature increase from the resulting exothermic reaction, viscosity of the ammonium mix increases from that of the acidified mixture.

Processing of liquefied melt comprises forming the usable fertilizer. This melt is sprayed into a granulator which contains an ammonia sparger through which anhydrous ammonia is discharged thereby completing the addition of nitrogen to the melt and raising the pH of the fertilizer melt to its final agronomic product pH. Preferably, the processing comprises drying the combination to a solids content of about 97% or greater, and preferably to about 98% or greater.

The low viscosity of the acidified mix and the ammoniated melt of the present invention facilitates fertilizer manufacturing by permitting the establishment of controls related to temperatures, pressures and times of reaction. The fluidity is advantageous so problems and inefficiencies commonly associated with solid debris clogging or otherwise blocking transport from one vessel to another and thereby requiring shutting down the system for maintenance are eliminated. Further, organic solid materials that are common in biosolids including, for example, plastic and hair, well known to cause blockages in conventional processing, are broken down and hydrolyzed to their monomer components because of the stringent hydrolysis reaction. The acid reaction hydrolyzes many polymers that may be present such as proteins and other materials including plastics, hair, and biologically active compounds (whether naturally present or artificially created), and breaks down and destroys many and nearly all and preferably all macromolecules and microorganisms that may be present. The acidification and subsequent ammonia environment creates a sterile fluid melt. This increases the safety to process workers and further simplifies and increases the efficiency of any cleaning or maintenance of the system that may be required periodically. The fertilizer produced is sterile thereby meeting the most stringent of the USEPA Class and EQ microbial standards. The physical chemical conditions created in the described embodiments eliminate or significantly reduce noxious odors in the resultant fertilizer.

Processing of liquefied melt mixture comprises forming the usable fertilizer. If the neutralization by the ammonia in the granulator is carried to completion of an agronomic pH for the fertilizer a complete salt is formed. Salt formation may be determined and in real time by the measurement of the pH of the mixture. Preferred pH values of the melt are between about pH 2.0 and about 3.0. The process continues and comprises coating the liquid fertilizer melt onto recycled fertilizer granules (bed) in a granulator. Optionally, a hardening or binding agent can be added in the granulator such as, for example, ligno-sulfonate, molasses, alum or a combination thereof is useful for ammonium sulfate-based fertilizer, or alternatively no hardening agent is utilized as is typical for formation of organic-containing ammonium phosphate fertilizers.

The process is preferably performed as a continuous process. Preferably the fertilizer is formed into granules and granules are screen separated by size. Preferably granules selected are about 4 mm or less, about 3 mm or less, about 2 mm or less, about 1 mm or less, about 0.5 mm or less, and generally between about 0.5 mm and about 4 mm. Granules that are of greater than 4 mm are crushed and combined with granules that are of less than 4 mm, preferably mostly between about 0.5 mm and 1 mm, and comprise recycled fertilizer granules that serve as granulator bed or receiving particles for the sprayed fertilizer melt from the ammoniation vessel. The system may also include one or more of a cooling and coating apparatus to reduce temperature and control dust prior to storage. Further, the dried granules are coated with an anti-dust and anti-caking coating while still hot from drying. The coated granules are then stored dry in a warehouse until optionally further coated and shipped to customers.

Preferably the nutrient release profile is a profile of the release of one or more of nitrogen, phosphorous, potassium, sulfur, iron, organics and combinations thereof, and can generally match the growth needs of a particular crop for the one or more of nitrogen, phosphorous, potassium, sulfur, iron, organics and combinations thereof. The nutrient release profile for fertilizers of this invention will basically be in two phases or stages. The first stage will be a rapid release of fertilizer from one to two weeks supplying the increased nutrient need for rapidly growing plants. The second stage of nutrient release will be of a slower nutrient release (often referred to as enhanced efficiency nutrient release) occurring after the first two weeks following application that lasts for an additional six to twelve weeks following the fertilizer application. This slow-release nutrient profile is due to the combination or bonding between the inorganic ammonium ions, sulfate ions or other ions present in the fertilizer with the charged organic molecules present in the fertilizer.

When the organic material contains cellulose as a major component it may be pretreated or reacted with an amount of acid, hydroxide or enzyme to accelerate the hydrolysis of the cellulose prior to being added to the first vessel. Optionally additional ingredients may be added to the organics prior to entering the acidification vessel or after ammoniation at the level of the granulation process. Such additions may be comprised of, for example, zinc sulfate and/or soluble forms of boron, nutrients, peptides, vitamins, polypeptides, amino acids, saccharides, polysaccharides, herbicides and/or pesticides or combination of such.

In addition, one or more agents that create additional charges or electrostatic state of the organic material can be added to the organic material, the mixture and/or the liquid mixture. Such agents include but are not limited to one or more of anionic and cationic chemicals, chelating agents, ionic sequestering agents, metal ions, citric acid, amino acids, glutamic acid, histidine, lysine, glycine, peptides, proteins, sugars, saccharides and polysaccharides, iron, sulfur, phosphorous and nitrogen-binding compounds and combinations thereof.

Another embodiment of the invention is directed to fertilizer made by the methods of the invention. Preferably fertilizers, when applied to a crops, release nitrogen and other nutrients to soil at a rate slower than nitrogen release by inorganic fertilizers containing the same nutrients such as urea or ammonium sulfate as a nitrogen source. Preferably the nutrients comprise one or more of nitrogen, phosphorus, potassium, sulfur, iron, manganese, magnesium, copper, calcium, selenium, boron, zinc and combinations thereof, and also preferably are chelated or electrostatically bound to the organic matter of the fertilizer. In other words, the organics form a matrix within the fertilizer which is comprised of a complex of variable chain length amphoteric charged organic molecules which can attract and electrostatically bind both positive and negatively charged inorganic nutrient molecules such as ammonium ion and sulfate ions, respectively. Preferably the resultant fertilizers are homogenous in composition.

Preferably the fertilizer of the present invention improves soil tilth, stress resistance of crops to heat and drought, and the micro-ecology of soil as compared to non-organic fertilizers. Also preferably, fertilizers of the invention have a hardness of between about 7 and about 12 pounds, more preferably between about 8 and about 10 pounds and/or a bulk density of between about 52 and about 56 pounds/cubic foot, and from about 8% to about 18% nitrogen, from about 0% to about 10% phosphorus, from about 0% to about 10% potassium, from about 5% to about 20% sulfur, from about 0% to about 5% iron, and from about 5% to about 20% organics. Also preferably, fertilizers, once applied to a crop, provide one or more nutrients to the crop sufficient for all or a portion of a single growing season.

The present invention allows for the generation of an ecologically and financially circular economy. This occurs ecologically when organics in the terms of food from the farm are consumed by society, organic wastes are created and successfully incorporated into a high nutrient fertilizer and returned to the farm to benefit soil health. This is accomplished financially when manufacture the fertilizer causes funds to be paid to the community businesses for the chemical inputs to create the said fertilizer. Once the fertilizer is manufactured it is sold back to community farms to create the soil nutrient environment necessary for maximum crop production.

Another advantage of the invention is that it may be performed in large scale, with continuous processing and under automation. No significant retention times are required, thus no delays, so that processing continues from start to finish without interruption as can be required when material is required to incubate for days as is common for some types of conventional biosolids processing as in composting or alkaline stabilization processes. The process of the invention is scalable to any amount of organic material from 2% up to 16% of the dry mass of the finished fertilizer granule.

Significantly this invention instructs that the degree of slow-release nutrients contained in the fertilizer may be adjusted on demand as in a “dial-up” or controlled ability for degree of slow-release or enhanced efficiency. Preferably the slow-release nutrient component is 20% to 70% of the said fertilizer. The degree of slow-release of the product can be adjusted by changing the amount of added organic materials such as wastewater plant biosolids, digested food stuffs, other microbially digested materials such as pharmaceutical fermentation waste, digested food waste; extracted liquid organic fraction from municipal solid waste; animal residuals; digested animal residuals and algae harvested from eutrophic surface water sources, and or humates, humic acids, fulvic acids or, iron humates containing fulvic and humic acids. Additionally, the amount of slow-release nutrient can by directly changed by adding specific stabilizing chemicals that react or bind with ammonia to create slowly soluble forms that are then slow-release nutrient compounds in the fertilizer. Additional nutrient-binding agents, such as nitrogen (ammonium ion) binding can be added to the process, preferably at the second mixer or granulator and include, for example, amino acids such as lysine, polypeptides containing nutrient-binding amino acids, and magnesium ammonium phosphate. The addition of such agents directly changes the percentage of nutrient ions that are slow-release. This ability to change the percent of nutrients that are slow release also directly increases the commercial value of said fertilizer as the conversion of nutrients to a slow-release form provides better crop production due to these nutrients being available over more of the growth cycle.

Slow-release or dual release fertilizers of the invention allow for a single application of fertilizer that provides a rapid first release (e.g., bolus) of nitrogen to growing or emerging plants such as commercial crops (e.g., fruits, vegetables, grains, grasses, trees), then a continued amount preferably over an entire or part of a growing season. This minimizes the number of fertilizer applications needed per crop which provides substantially savings in application expenses.

As the fertilizer product produced contains both organics and a high-content of desirable nitrogen and phosphorus (or sulfur), a preferred embodiment results in a variety of specific nutrient analysis fertilizers of which the following are typical: 14-24-0-10-1-15 or 16-1-0-20-1-16 (Nitrogen-Phosphorus-Potassium-Sulfur-Iron-Organics). The slow or controlled enhanced efficiency release granular fertilizer is 98 percent dry and exceeds the United States Environmental Protection Agency (USEPA) Class A requirements and Exceptional Quality (EQ) Standards.

The finished product is upon manufacture a sterile fertilizer having substantially no or no detectable amount of viable microorganisms, such as pathogen-indicator microorganisms such as fecal coli or Salmonella, or viruses harmful to animals or humans.

Although the fertilizer is rendered sterile during manufacturing, contamination can be expected from external air-borne microorganisms or by microorganisms deposited by animal or other contamination during storage or use.

The granule storage facility or warehouse, usually incorporating bins or silos to contain the granules, must be dry to prevent agglomeration of the granules leading to degradation and destruction. In any case, because the fertilizer product is dry and predominantly inorganic ammonium salts upon storage it will not support microorganism multiplication at a rate which would lead to an animal or public health problem.

The following example illustrates embodiments of the invention but should not be viewed as limiting the scope of the invention.

### EXAMPLES

### Example 1

A typical manufacturing plant operates at a production rate of about 450,000 tons of finished granular fertilizer per year. An organic processing center (OPC) for the purpose of enabling the manufacture of an organically-enhanced ammonium sulfate or ammonium phosphate green” fertilizers was constructed at the fertilizer plant. This OPC facility receive organics directly from trucks or rail cars and contains its own air processing for odor control of emissions from organic unloading to the facility or from the handling and acidification of said organics. An amount (205 dry t/d) of a third-party source of dried biosolids pellets at 92% or greater solids are imported per day from a distant municipal waste treatment works. The solid biosolid pellets are hard, and many with diameters 3 mm and larger with some 5 mm and larger. If solids do not dissolve or disassociate well in an acidified mix at 22% solids, additional conditioning processes can be utilized. These dry biosolids in pellet or granule form are added to a conditioning soak and softening tank along with residual process water from the existing granulation plant to form a solution of about 22% solids and cause the wetting and softening of the hard dried granule biosolids. This softening was carried out in a large recirculation tank at ambient temperatures for 30 minutes. The softening organics were then passed through a commercially-available mechanical grinder to reduce the average diameter size of the softened dried biosolids to less than 0.5 mm. This mix will produce the 23% wet biosolids mix to feed to the primary acidification reaction vessel). This conditioned-organics mix is then pumped into the acidification vessel wherein at the orifice of the circulation tank it is mixed with 258 t/d of 98% concentrated sulfuric acid in an amount pre-calculated to yield a degree of heat of hydration of 110° C. (200° F.) to commence hydrolysis of the macromolecules present in the organic material. The sulfuric acid is added into the acidification vessel via a dip-tube or dip-pipe which extending into this first vessel to the mixing zone created by the recirculation mechanism within the acidification vessel. The contents of the acidification vessel are mixed by recirculation within this cylindrical vessel for between 15 and 30 minutes. In this primary acidification vessel the contained proteins from the community biosolids organics are hydrolyzed to various length polypeptides and monomeric amino acids. Other macro-organic compounds, such as dewatering polymers, carbohydrates and lipids are also hydrolyzed to smaller molecular forms thereby increasing the fluidity of the contents of the vessel to less than 2,000 cP, and preferably less than 1,000 cP. This fluidized acidified mix is then pumped through an acid-protected pipe wherein approximately 10 feet from the end of this pipe an amount of 47% phosphoric acid (461 t/d) is added via a tee-mixer/reactor. This phosphoric acid addition completes the acidified organic mix which in this plant continues to react in a tubular pipe for an additional 5 seconds as it flows to the ammoniation reaction vessel present in the existing granulation facility.

The liquid acidified mix with a preferred viscosity of less than 1,000 cP is transferred to an ammoniation vessel, also in a tee-mixer/reactor form (see FIG. 4), wherein it is mixed with vaporized or liquid anhydrous ammonia (110 t/d) sufficient to raise the temperature of the mix to over 150° C. (300° F.) and the internal pressure of this ammoniation step is over 35 psi. The ammoniated mix is maintained in a pipe flow for 5 to 20 seconds for reactions before it is discharged via a spray to a granulator. The discharged mix or melt is increased in viscosity compared to the discharge of the primary acidification vessel but less than 4,000 cP and preferably less than 2,000 cP. This discharged melt is under pressure and therefore when it enters the granulator is sprayed onto a receiving bed of crushed fertilizer material or undersized fertilizer material or fertilizer dust material collected from the various dust collectors contained in the process air treatment system. The spray coats the receiving fertilizer material and gradually builds up a series of accreted coatings or less preferably an agglomerated material such that the granular fertilizer is produced in which the majority of the material is of the proper product size such as the 1.7 mm to 3.0 mm (170 sgn to 300 sgn; “size guide number”) diameter granules that are suitable for use in commercial agriculture. The coated granules are brought to a final pH in the range of pH 4.0 to pH 5.0 and preferably about pH 4.5 by the addition of more anhydrous ammonia (43 tons/d) through the sparger. This material is then discharged from the granulator to a belt which delivers the material to a rotary dryer where the material is dried to over 97% solids in a rotary drum dryer and then screened to one of three commercial sizes of 1.7 mm to 1.9 mm, 1.2 mm to 1.4 mm, and to 2.6 mm to 3.0 mm. All smaller material is returned to the granulator as part of the recycle bed. All larger material is crushed in a chain mill and then returned to the granulator as part of the recycle. A portion of the proper sized product, preferably 2.6 mm to 3.0 mm for commercial product size, may also be returned to the recycle bed to maintain the mass balance of the production process. All of the steps of this process were maintained in this example under negative pressure so that no process dust or odors are released into the manufacturing environment. All process air was treated through a robust odor control system, such as a regenerative thermal oxidizer (RTO) such that no noxious odors were perceived at the fence line of the manufacturing property. Scrubbed nutrients such as ammonium, now ammonium sulfate, were returned to a residual process water tank wherein it was added to the organic mix prior to entering the acidification vessel to help control the solids and fluidity of the conditioned mix. The fertilizer manufactured by this process contained a slow-release percentage of nitrogen of approximately 30% of the total nitrogen in the product. A component of the slow-release nitrogen is available to a crop normally about two weeks after application with the remainder slowly available over time—usually about 8 to 12 weeks dependent upon environmental conditions. This slow-release nitrogen is in the form of an organic matrix in which the positive charged ammonium ions are electrostatically bound to negative charges on the organic compounds such as polypeptides and amino acids that comprise the core of the matrix. The product of this example of the invention contained a 98% dry granular mono-ammonium phosphate fertilizer with a nutrient formulation of 14-24-0-10-0-15 (N—P—K—S—Fe-Organic) by dry weight.

### Example 2

A system for the manufacture of a solid fertilizer contains: a softening vessel containing organic material and an aqueous solution; a grinding vessel operationally connected to the softening vessel to allow for transfer of the organic material and containing a grinding apparatus; an acidification vessel operationally connected to the grinding vessel to allow for transfer of organic material and addition of a mineral acid; wherein the acidification vessel is a tee-mixer/reactor, a pipe reactor, a tube reactor, or a cylindrical tank reactor and allows for an input of anhydrous ammonia.; and a granulator operationally connected to the acidification vessel; and a dryer operationally connected to the granulator. The specifications of the system, optional steps, and the operational process are set forth herein.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A method for the manufacture of a solid fertilizer comprising:
conditioning dry organic material by soaking the solid organic material in an aqueous solution followed by grinding of the soaked organic material;
hydrolyzing the soaked organic material by adding a mineral acid to create an exothermic reaction forming an acidified mixture;
treating the acidified mixture with anhydrous ammonia under pressure forming an ammoniated melt;
treating the ammoniated melt in a granulator with additional anhydrous ammonia forming granules; and
drying the granules forming the solid fertilizer.

2. The method of claim 1, wherein the dray organic material comprises from about 60% to about 100% solids.

3. The method of claim 1, wherein the dry organic material is selected from the group consisting of one or more of municipal biosolids, agricultural solids, industrial solids, solid waste materials, solid material harvested from eutrophic surface water sources, solids of digested or undigested animal manures, solids of animal or human food stuffs, solid residuals, solid microorganism-containing materials, solid extracted waste fractions, solid humates, solid organic materials containing humates, humic acid, and/or fulvic acid, solid microbial digests of organic products, solid organic biosolids, solid pharmaceutical wastes, solid fermentation wastes, and solid wastewater plant materials.

4. The method of claim 1, wherein the solid organic material comprises 10% or less of a liquid.

5. The method of claim 1, wherein the aqueous solution comprises a dilute acid solution, a dilute alkali solution, an enzyme solution, or a combination thereof.

6. The method of claim 1, wherein the soaked organic material contains from about 20% to about 50% solids.

7. The method of claim 1, wherein soaking is performed at ambient temperature for from about 1 minute to about 30 minutes.

8. The method of claim 1, wherein the grinding comprises treating with a mixer, a grinder, a pug mill or a ball mill configured to reduce particle size of the soaked organic material.

9. The method of claim 1, wherein grinding is performed at ambient temperature for from about 1 minute to about 30 minutes.

10. The method of claim 1, wherein the particle size comprises diameters of from about 2 mm to about 0.1 mm.

11. The method of claim 1, wherein, prior to hydrolyzing, the soaked organic material is pretreated with an acid, a hydroxide, or an enzyme that promotes hydrolysis.

12. The method of claim 1, wherein the mineral acid comprises sulfuric acid, phosphoric acid or both sulfuric and phosphoric acids.

13. The method of claim 1, wherein the mineral acid comprises at least two acids including sulfuric acid which are added in sequential steps with sulfuric acid added first.

14. The method of claim 1, wherein the hydrolyzing is performed at from about 170° F. (76° C.) to about 220F (104° C.) for about 6 minutes to about 60 minutes.

15. The method of claim 1, wherein the hydrolyzing is performed at atmospheric pressure.

16. The method of claim 1, wherein the hydrolyzing is performed at a pressure of from about 15 psi to about 36 psi.

17. The method of claim 1, wherein the pressure of the anhydrous ammonia is from about 28 psi to about 40 psi.

18. The method of claim 1, wherein the pH of the ammoniated melt is about pH 1.0 or less.

19. The method of claim 1, wherein the pH of the ammoniated melt is about pH 0.1 or less.

20. The method of claim 1, wherein the acidified mixture is from about 2,000 cP to about 1,000 cP or less.

21. The method of claim 1, wherein the ammoniated melt is at a temperature of from about 280° F. (138° C.) to about 330° F. (165° C.).

22. The method of claim 1, wherein the solid fertilizer has a two-phase slow-release nutrient profile.

23. The method of claim 1, wherein the granules are coated with an agent.

24. The method of claim 23, wherein the agent comprises a hardener, a dedusting agent, a nutrient, a bioactive agent, or a combination thereof.

25. A fertilizer made by the method of claim 1.

26. A solid fertilizer comprised of at least partially hydrolyzed organic material complexed with one or more nutrients which are chelated or electrostatically bound to the hydrolyzed organic material, wherein the solid fertilizer comprises granules with a hardness of from about 4 to about 12 pounds or a bulk density of from about 50 to about 58 pounds/cubic foot.

27. The solid fertilizer of claim 26, which is homogenous and contains an added plant nutrient.

28. The solid fertilizer of claim 26, wherein the plant nutrient is selected from the group consisting of one or more of nitrogen, phosphorus, potassium, sulfur, iron, manganese, magnesium, copper, calcium, selenium, boron, and zinc.

29. The solid fertilizer of claim 26, which has a slow-release nutrient profile.

30. The solid fertilizer of claim 29, wherein, the slow-release nutrient profile allows for the release of nitrogen to a soil at a rate slower than nitrogen release by fertilizer containing urea or ammonium sulfate as a nitrogen source.

31. The solid fertilizer of claim 26, which contains from about 2.0% to about 16% of organic material.

32. The solid fertilizer of claim 26, wherein the granules contain an agents that provide an electrostatic charge to the organic material.

33. The solid fertilizer of claim 32, wherein the agent is selected from the group consisting of one or more of an anionic chemical, a cationic chemical, a chelating agent, an ionic sequestering agent, a metal ion, citric acid, an amino acid, glutamic acid, histidine, lysine, glycine, a peptide, a protein, a sugar, a saccharide or a polysaccharide, iron, sulfur, phosphorous, and a nitrogen-binding compound.

34. The solid fertilizer of claim 26, which improves soil tilth, stress resistance of crops to heat and drought, and the micro-ecology of soil as compared to a non-organic fertilizer.

35. The solid fertilizer of claim 26, which contains from about 8% to about 17% nitrogen, from about 0% to about 30% phosphorus, from about 0% to about 10% potassium, from about 5% to about 22% sulfur, from about 0% to about 5% iron, and from about 4% to about 20% organic compounds.

36. The solid fertilizer of claim 26, which, when applied to a crop, provides sufficient nutrients for all or a portion of a single growing season.

37. A system for manufacture of a solid fertilizer comprising:
a softening vessel containing organic material and an aqueous solution;
a grinding vessel operationally connected to the softening vessel to allow for transfer of the organic material and containing a grinding apparatus; and
an acidification vessel operationally connected to the grinding vessel to allow for transfer of organic material and addition of a mineral acid;
wherein the acidification vessel is a tee-mixer/reactor, a pipe reactor, a tube reactor, or a cylindrical tank reactor and allows for an input of anhydrous ammonia.; and
a granulator operationally connected to the acidification vessel; and
a dryer operationally connected to the granulator.
